(19) United States
(12) Patent Application Publication
(10) Pub. No.: US 2014/0257633 A1
(43) Pub. Date: Sep. 11, 2014

(54) Dynamic Rollover Meter

(71) Applicant: Thomas Richard Alexander, Tennessee Ridge, TN (US)

(72) Inventor: Thomas Richard Alexander, Tennessee Ridge, TN (US)

(21) Appl. No.: 14/195,084

(22) Filed: Mar. 3, 2014

Related U.S. Application Data
(60) Provisional application No. 61/772,759, filed on Mar. 5, 2013.

(51) Int. Cl. B60R 21/0132

(52) U.S. Cl. CPC B60R 21/0132
USPC 701/36; 701/1

(57) ABSTRACT

A rollover meter device is disclosed that prevents vehicle rollover and minimizes the harm and damage caused if a rollover occurs. The rollover meter device comprises a meter housing component and a gauge face component that displays current angle of the vehicle. The meter housing component comprises at least one weighted pendulum assembly and a pair of limit switches positioned on opposing sides of the pendulum, such that swinging of the pendulum contacts cams which actuate one of the limit switches, which then alerts a user that a critical angle has been reached. The pendulum assembly is held in place by a rotation rod and a pair of outer bushing assemblies that are secured to the ends of the rotation rod to allow it to rotate. Furthermore, the meter housing component can be in electrical communication with a vehicle's gas supply, ignition, blade rotation, and/or Power Take Off (PTO).

### CROSS-REFERENCE

This application claims priority from Provisional Patent Application Ser. No. 61/772,759 filed Mar. 5, 2013.

### BACKGROUND

Vehicle rollovers are a common cause of accidents, especially in the world of agriculture. Rollovers can cause severe vehicular damage, bodily harm and other problems, and a person may have to spend a lot of time and money on hospital bills and repairs. An effective solution is necessary.

The present invention warns a vehicle operator of an impending rollover, and changes to suit various conditions without being reprogrammed. The rollover meter device also operates in even the harshest conditions, and offers both audible and visible warnings of rollover conditions. The rollover meter device can shut off the engine and gas in the event of a rollover.

### SUMMARY

The following presents a simplified summary in order to provide a basic understanding of some aspects of the disclosed innovation. This summary is not an extensive overview, and it is not intended to identify key/critical elements or to delineate the scope thereof Its sole purpose is to present some concepts in a simplified form as a prelude to the more detailed description that is presented later.

The subject matter disclosed and claimed herein, in one aspect thereof, comprises a rollover meter device that prevents vehicle rollover and minimizes the harm and damage caused if a rollover occurs. The rollover meter device comprises a meter housing component that can be in electrical communication with a vehicle, and the meter housing component comprises at least one weighted pendulum assembly, at least two limit switches, a rotation rod, and a pair of outer bushing assemblies. The meter rollover device can be utilized with almost any standard vehicle. Typically, the meter housing component is rigidly attached behind the steering wheel, dashboard, or on the steering column of any vehicle. Furthermore, the meter housing component comprises at least one weighted pendulum assembly and a pair of limit switches positioned on opposing sides of the weighted pendulum assembly at a predetermined distance away from the pendulum assembly, such that swinging of the pendulum allows the pendulum to contact one of the limit switches, which then alerts a user that a critical angle has been reached. The weighted pendulum assembly is held in place by a rotation rod and a pair of outer bushing assemblies that are secured to the ends of the rotation rod to allow the rotation rod to rotate, and thus allows the weighted pendulum assembly to swing back-and-forth. Furthermore, the meter housing component can be in electrical communication with a vehicle's gas supply, ignition, blade rotation, and/or Power Take Off (PTO), such that if a critical angle is exceeded and rollover occurs, the rollover meter system automatically shuts off the vehicle's gas supply, ignition, blade rotation, and/or PTO, and an alarm sounds.

In a preferred embodiment, the meter housing component comprises two weighted pendulum assemblies positioned at different lengths such that the pendulums can contact limit switches when different angles are encountered by the vehicle (i.e., tilting of the vehicle). Thus, when multiple pendulum assemblies of different lengths are used, multiple critical angles can be detected and appropriate output can be transmitted to the user. The meter housing component further comprises a gauge face component that displays a plurality of control components for monitoring current angle and critical angle of the vehicle and control corrections required for safe operations. Specifically, the gauge face component can comprise an adjustment knob component that allows a user to adjust warnings for a critical angle of a specific vehicle, and a dashboard indicator component that alerts a user of the current angle and control corrections required. Further, the gauge face component can also comprise red and yellow flashing lights, wherein the yellow light flashes when there is danger of or possibility of a lateral rollover, and the red light flashes when a lateral rollover is expected rather than possible.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1A illustrates a perspective view of the interior of the rollover meter device in accordance with the disclosed architecture.

FIG. 1B illustrates a perspective view of the circuit board associated with the gauge face of the rollover meter device in accordance with the disclosed architecture.

FIG. 2 illustrates a perspective view of the rollover meter device in accordance with the disclosed architecture.

FIG. 3 illustrates a perspective view of the rollover meter device affixed behind a steering wheel of a vehicle in accordance with the disclosed architecture.

FIG. 4 illustrates a perspective view of the rollover meter device in use in accordance with the disclosed architecture.

FIG. 5 illustrates a perspective view of the rollover meter device in use with the warning level being reached in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof It may be evident, however, that the innovation can be practiced without these specific details. In other instances, well-known structures and devices are shown in block diagram form in order to facilitate a description thereof

The present invention warns a vehicle operator of an impending rollover, and changes to suit various conditions without being reprogrammed. The rollover meter device also operates in even the harshest conditions, and offers both audible and visible warnings of rollover conditions. The rollover meter device can shut off the engine and gas in the event of a rollover.

The rollover meter device comprises a meter housing component that can be in electrical communication with a vehicle, and a gauge face component that displays current angle of the vehicle. The meter housing component comprises at least one weighted pendulum assembly and a pair of limit switches positioned on opposing sides of the pendulum, such that swinging of the pendulum allows the pendulum to contact one of the limit switches, which then alerts a user that a critical angle has been reached. The pendulum assembly is held in place by a rotation rod and a pair of outer bushing assemblies that are secured to the ends of the rotation rod to allow it to rotate, and thus allows the pendulum assembly to swing back-and-forth. Furthermore, the meter housing component is in electrical communication with a vehicle's gas supply, ignition, blade rotation, and/or Power Take Off (PTO).

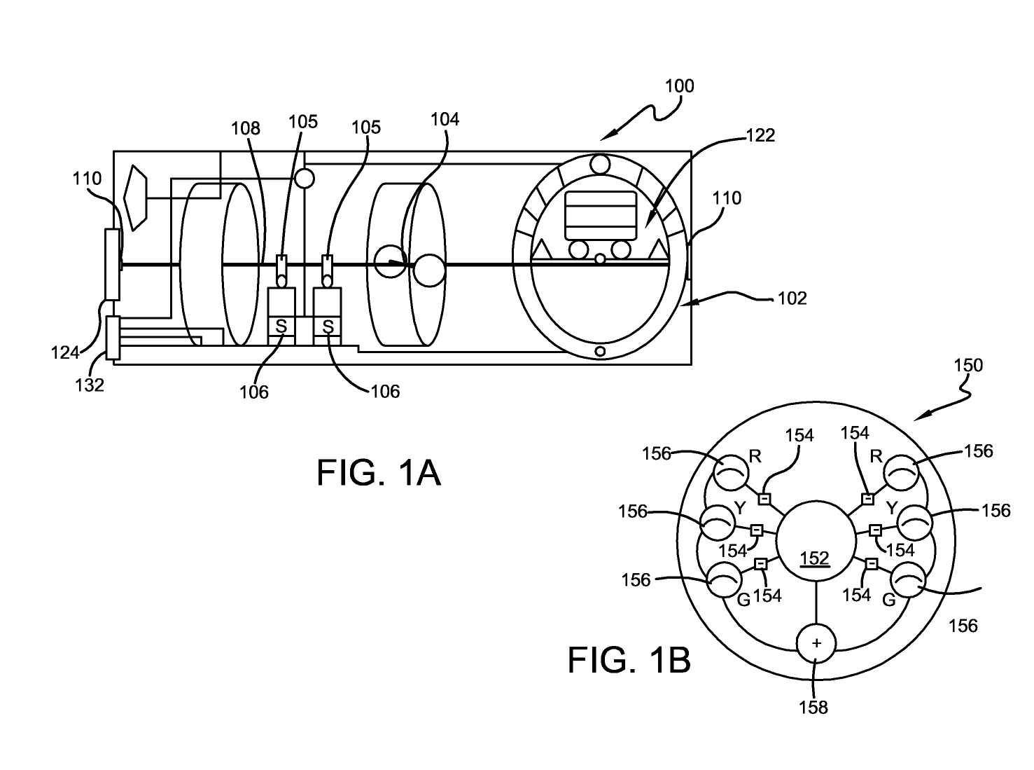

Referring initially to the drawings, FIGS. 1A-B and 2-3 illustrate the rollover meter device 100 that prevents vehicle rollover and minimizes the harm and damage caused if a rollover occurs. The rollover meter device 100 comprises a meter housing component 102 that is in electrical communication with a vehicle, and the meter housing component 102 comprises at least one weighted pendulum assembly 104, at least two limit switches 106, a rotation rod 108, and a pair of outer bushing assemblies 110 (as shown in FIG. 1A).

The meter rollover device can be utilized with almost any standard vehicle, such as a tractor, an ATV, a golf cart, a lawnmower, a car, a truck, etc. The meter housing component 102 comprises a top end 112, a bottom end 114, opposing sides 116, a front surface 118, and a back surface 120. Typically, the meter housing component 102 can be any suitable shape as is known in the art without affecting the overall concept of the invention, such as a rectangular prism, a cylinder, etc. The meter housing component 102 would generally be constructed of metal or homogeneous plastics, such as polyvinyl chloride (PVC), acrylonitrile butadiene styrene (ABS), polycarbonate (PC), composite polymers, etc., though any other suitable material may be used to manufacture the meter housing component 102 as is known in the art without affecting the overall concept of the invention.

The meter housing component 102 can also comprise a variety of colors and designs to suit user and manufacturing preference. While the shape and size of the meter housing component 102 may vary greatly depending on the wants and needs of a user, the meter housing component 102 is approximately between 0 and 3 inches in height as measured from a top end 112 to a bottom end 114, and approximately between 0 and 3 inches wide as measured from opposing sides 116, and approximately between 3 and 5 inches thick as measured from a front surface 118 to a back surface 120. Typically, the meter housing component 102 is made up of a threaded cylinder, which is sealed on each end with threaded caps and o-rings to protect it from the outside environment.

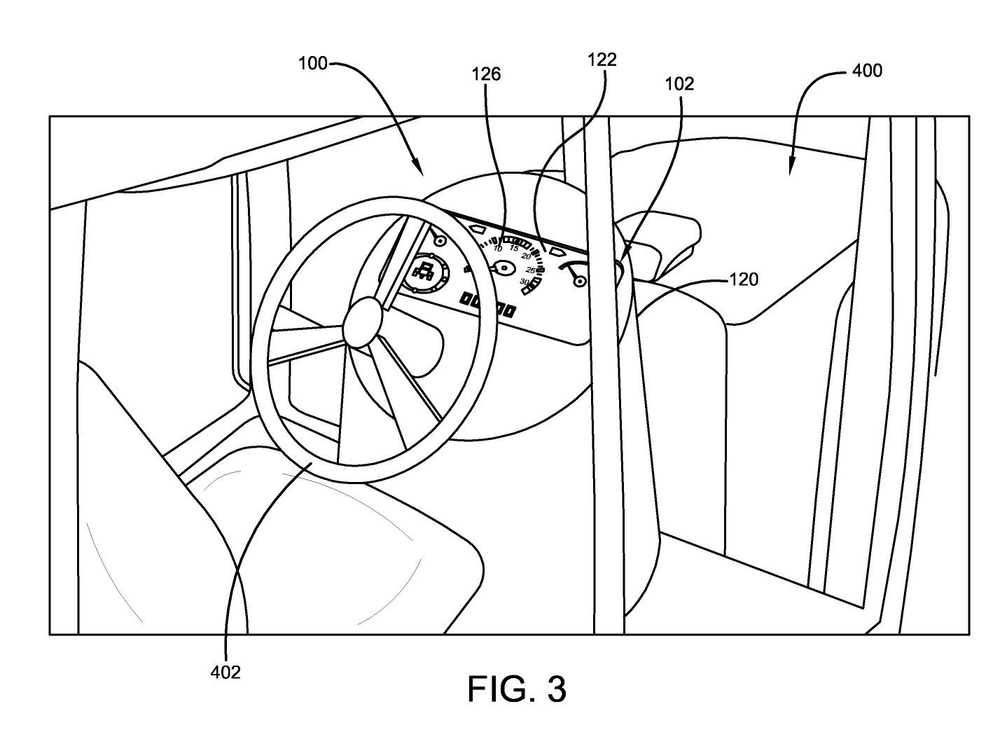

Typically, the meter housing component 102 is rigidly attached behind the steering wheel 402, on the steering column or dashboard of any vehicle 400 (as shown in FIG. 3). The meter housing component 102 can be secured via any suitable securing means as is known in the art, such as bolting, welding, riveting, or snapping in via plastic clips, etc., as long as the meter housing component 102 is rigidly attached to the vehicle to be able to measure (determine) the critical angle of the vehicle. Further, the meter housing component 102 can be secured to any suitable position in the vehicle as is known in the art, as long as the meter housing component 102 can function to determine the critical angle of the vehicle. The meter housing component 102 can be pre-installed in the vehicle or can be an aftermarket addition to any vehicle.

Furthermore, the meter housing component 102 comprises at least one weighted pendulum assembly 104, typically the meter housing component 102 comprises two weighted pendulum assemblies 104, but any suitable number of pendulum assemblies 104 can be used without affecting the overall concept of the invention. If multiple weighted pendulum assemblies 104 are used, then the pendulums are positioned at different lengths such that the pendulums can contact limit switches 106 when different angles are encountered by the vehicle (i.e., tilting of the vehicle). Typically, up to three pendulum assemblies maybe needed for a vehicle.

Specifically, each weighted pendulum assembly 104 used also comprises a pair of limit switches 106 associated with it, positioned on opposing sides of the weighted pendulum assembly 104 at a predetermined distance away from the pendulum assembly 104, such that swinging of the pendulum allows the pendulum to contact one of the limit switches 106, which then alerts a user that a critical angle has been reached. Thus, when multiple pendulum assemblies 104 of different lengths are used, multiple critical angles can be detected and appropriate output can be transmitted to the user. Typically, the pendulum assemblies 104 drive cams 105 that actuate the limit switches 106, and the pendulum assemblies 104 do not actually touch the limit switches 106. However, any suitable means for contacting the limit switches 106 can be used as is known in the art without affecting the overall concept of the invention.

The weighted pendulum assemblies 104 are held in place by a rotation rod 108 and a pair of outer bushing assemblies 110 that are secured to the ends of the rotation rod 108 to allow the rotation rod 108 to rotate, and thus allows the weighted pendulum assemblies 104 to swing back-and-forth. The rotation rod 108 is typically a stainless steel rotation rod 108, but any other suitable material can be used to manufacture the rotation rod 108 as is known in the art without affecting the overall concept of the invention. Typically, the pendulum assembly 104 is attached to a threaded rod that slides through a threaded tube and then tightens against the rotation rod 108 wherever needed to center the pendulum assembly 104 as necessary. However, any suitable means for positioning the pendulum assembly 104 can be used as is known in the art without affecting the overall concept of the invention.

Furthermore, the meter housing component 102 is in electrical communication with a vehicle's gas supply, ignition, blade rotation, and/or Power Take Off (PTO), such that if a critical angle is exceeded and rollover occurs, the rollover meter system 100 automatically shuts off the vehicle's gas supply, ignition, blade rotation, and/or PTO, and an alarm sounds.

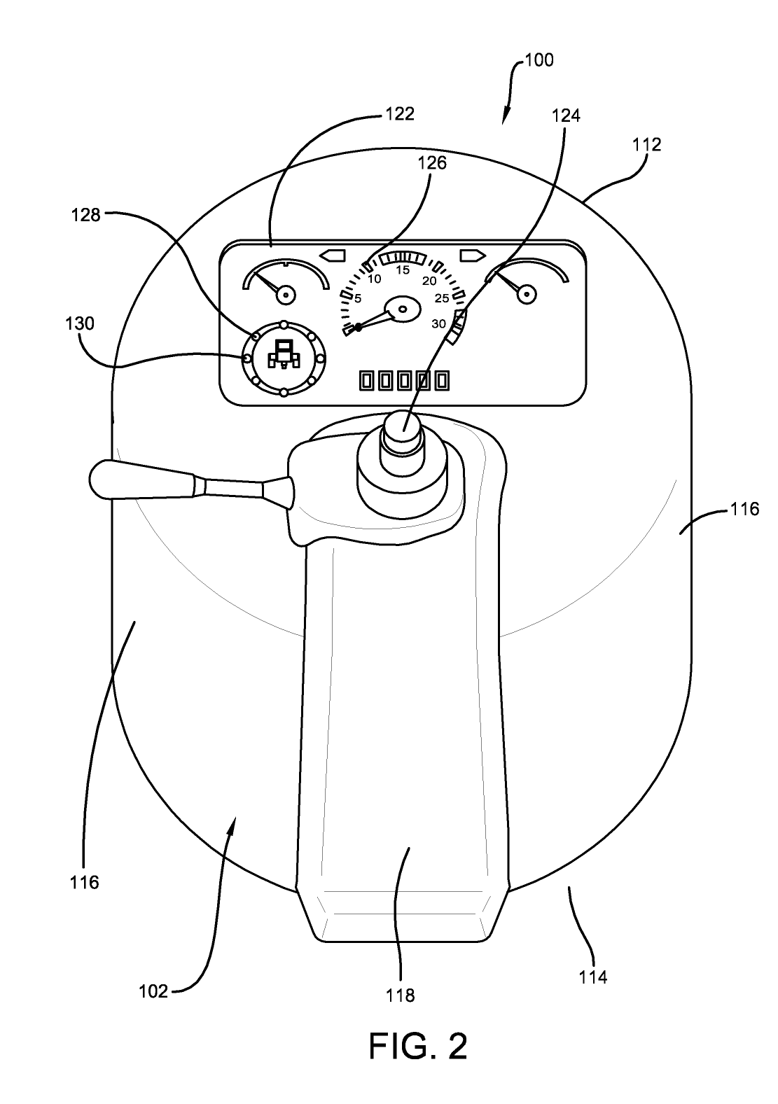

The meter housing component 102 further comprises a gauge face component 122 that displays a plurality of control components for monitoring current angle and critical angle of the vehicle and control corrections required for safe operations (as shown in FIG. 2). Specifically, the gauge face component 122 can comprise an adjustment knob component 124 that allows a user to adjust warnings for a critical angle of a specific vehicle. The adjustment knob component 124 can be calibrated easily and can be equipped with knowledge of a calculated critical angle for any specific vehicle.

The gauge face component 122 can also comprise a dashboard indicator component 126 that alerts a user of the current angle and control corrections required. The dashboard indicator component 126 displays the current angle of the vehicle and any corrections deemed necessary so that the vehicle does not rollover. Further, the gauge face component 122 can also comprise red and yellow flashing lights 128 and 130 respectively. The yellow light 130 flashes when there is danger of or possibility of a lateral rollover. The red light 128 flashes when a lateral rollover is expected rather than possible. Any other suitable flashing lights displaying the angles can be used with the gauge face component 122 as is known in the art to display any number of things without affecting the overall concept of the invention.

Specifically, the gauge face component 122 will be made up of the end cap, an o-ring, a clear lens, the dashboard indictor component 126 attached to the rotation rod 108, the background scene of the display meter and a circuit board 150 behind the display meter. The circuit board 150 (as shown in FIG. 1B) is made up of a (1) course ohm potentiometer 152, (6) fine potentiometers 154, (6) colored LED's 156 and a power source 158. The course potentiometer is mounted and keyed to the rotation rod 108 and as the pendulum assembly 104 rotates the rotation rod 108 it changes the ohm value of the potentiometer. The critical angles are calculated to a corresponding ohm value and when the course potentiometer reaches a critical angle it combines with one of the six fine potentiometers and decreases in resistance to turn on an associated light. The lights will come on in series until the maximum critical angle is reached.

Additionally, the meter housing component 102 comprises a sealed plug 132 around its electrical connections to protect the meter housing component 102 from the outside elements. The sealed plug 132 is the place where the electrical communication between the meter housing component 100 and vehicle 400 can be made.

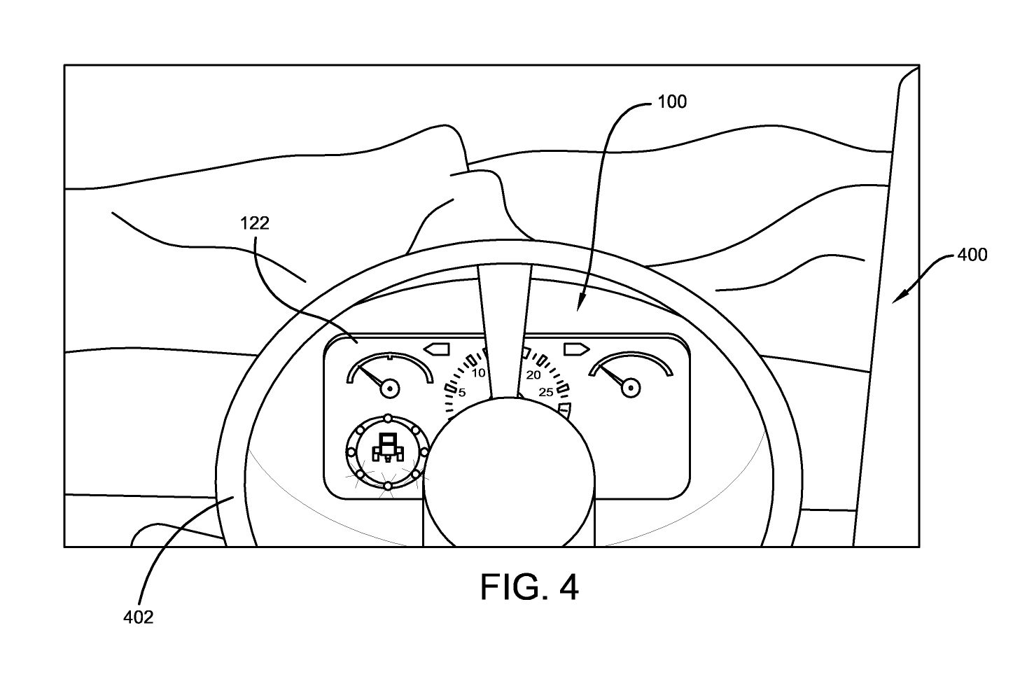

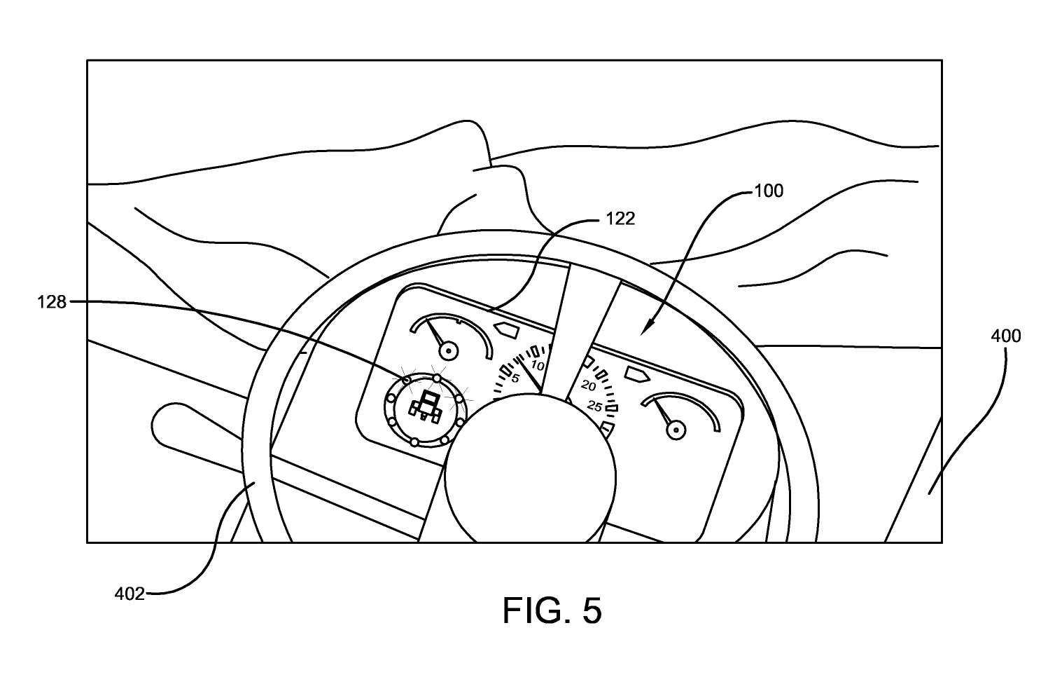

FIGS. 4-5 illustrate the rollover meter device 100 in use. As stated supra, the rollover meter device 100 comprises a meter housing component 102 that is in electrical communication with a vehicle 400, and a gauge face component 122 that displays current angle of the vehicle 400. The meter housing component 102 comprises at least one weighted pendulum assembly 104 and a pair of limit switches 106 positioned on opposing sides of the pendulum 104, such that swinging of the pendulum 104 allows the pendulum 104 to contact one of the limit switches 106, which then alerts a user that a critical angle has been reached. The pendulum assembly 104 is held in place by a rotation rod 108 and a pair of outer bushing assemblies 110 that are secured to the ends of the rotation rod 108 to allow it to rotate, and thus allows the pendulum assembly 104 to swing back-and-forth. Furthermore, the meter housing component 102 is in electrical communication with a vehicle's gas supply, ignition, blade rotation, and/or Power Take Off (PTO).

In operation, a user (not shown) would choose the size and/or specific design of the rollover meter device 100 that meets their needs and/or wants, depending on the vehicle 400 that it will be attached to. The user would then rigidly secure the meter housing component 102 behind the steering wheel 402 to the steering column or dashboard of the vehicle 400 (as shown in FIGS. 3-4). The user would then secure the wiring connection from the meter housing component 102 to the vehicle 400, such that the meter housing component 102 is in electrical communication with the vehicle 400. Further, the user would then secure the wiring connection from the meter housing component 102 to the vehicle's gas supply, ignition, blade rotation, and/or Power Take Off (PTO), such that the meter housing component 102 is in electrical communication with the vehicle's gas supply, ignition, blade rotation, and/or Power Take Off (PTO).

Once the meter housing component 102 is in electrical communication with the vehicle 400 and its gas supply, ignition, blade rotation, and/or PTO, the user can calibrate the adjustment knob component 124 with the calculated critical angle for the specific vehicle 400 being used. The user can then calibrate the critical limits, which if reached by the vehicle 400, would set off an alarm, cause a light to flash, etc. The user can then operate the vehicle 400 normally, and if a critical angle is reached, or a predetermined critical limit, then the gauge face component 122 will emit an alarm or warning, and/or flash a light (as shown in FIG. 5). For example, if there is danger of or possibility of a lateral rollover, then a yellow light 130 will flash, and if a lateral rollover is expected rather than possible, a red light 128 flashes. Furthermore, if a critical angle is exceeded and rollover occurs, the rollover meter system 100 can automatically shut off the vehicle's gas supply, ignition, blade rotation, and/or PTO, and an alarm sounds. Thus, the rollover meter device (system) 100 prevents vehicle rollover and minimizes the harm and damage caused if a rollover occurs.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rollover meter device for use with a vehicle, comprising:
a meter housing component comprising:
at least one weighted pendulum assembly;
at least a pair of limit switches;
wherein tilting of the vehicle causes the at least one weighted pendulum assembly to contact one of the pair of limit switches;
a rotation rod for securing the at least one weighted pendulum assembly; and
a pair of outer bushing assemblies that are secured to ends of the rotation rod to allow the rotation rod to rotate.

2. The rollover meter device of claim 1, wherein the meter housing component is in electrical communication with a vehicle's gas supply, ignition, blade rotation, or Power Take Off (PTO), such that if a critical angle is exceeded and rollover occurs, the rollover meter system automatically shuts off the vehicle's gas supply, ignition, blade rotation, or PTO, and an alarm sounds.

3. The rollover meter device of claim 1, further comprising a gauge face component that displays a plurality of control components for monitoring current angle of the vehicle and control corrections required for safe operations.

4. The rollover meter device of claim 3, wherein one of the control components is a adjustment knob component that allows a user to adjust warnings for a critical angle of a specific vehicle.

5. The rollover meter device of claim 4, wherein one of the control components is a dashboard indicator component that alerts a user of the current angle and control corrections required.

6. The rollover meter device of claim 5, wherein one of the control components is a yellow light that flashes when there is danger of or possibility of a lateral rollover.

7. The rollover meter device of claim 6, wherein one of the control components is a red light that flashes when a lateral rollover is expected rather than possible.

8. The rollover meter device of claim 1, wherein the rotation rod is a stainless steel rotation rod.

9. The rollover meter device of claim 1, wherein the meter housing component further comprises a sealed plug to protect the meter housing component from outside elements.

10. The rollover meter device of claim 1, further comprising a second weighted pendulum assembly of a different length than the at least one weighted pendulum assembly.

11. The rollover meter device of claim 10, further comprising a second pair of limit switches associated with the second weighted pendulum assembly.

12. The rollover meter device of claim 1, wherein the meter housing component is rigidly attached behind a steering wheel of the vehicle.

13. A rollover meter device for use with a vehicle, comprising:
a meter housing component comprising:
a first pendulum assembly associated with a first pair of limit switches;
a second pendulum assembly of a different length than the first weighted pendulum assembly and associated with a second pair of limit switches;
a first pair of cams associated with the first pair of limit switches;
a second pair of cams associated with the second pair of limit switches;
wherein the first and second pendulum assemblies drive the first and second pair of cams to actuate the first pair and the second pair of limit switches;
wherein tilting of the vehicle causes a first or second pendulum assembly to contact at least one of the first and second pair of cams which then actuates one of the first or second pairs of limit switches;
a rotation rod for securing the first and second pendulum assemblies;
a pair of outer bushing assemblies that are secured to ends of the rotation rod to allow the rotation rod to rotate; and
wherein the meter housing component is in electrical communication with a vehicle's gas supply, ignition, blade rotation, or Power Take Off (PTO), such that if a critical angle is exceeded and rollover occurs, the rollover meter system automatically shuts off the vehicle's gas supply, ignition, blade rotation, or PTO, and an alarm sounds.

14. The rollover meter device of claim 13, further comprising a gauge face component that displays a plurality of control components for monitoring current angle of the vehicle and control corrections required for safe operations.

15. The rollover meter device of claim 14, wherein one of the control components is a adjustment knob component that allows a user to adjust warnings for a critical angle of a specific vehicle.

16. The rollover meter device of claim 15, wherein one of the control components is a dashboard indicator component that alerts a user of the current angle and control corrections required.

17. The rollover meter device of claim 16, wherein one of the control components is a yellow light that flashes when there is danger of or possibility of a lateral rollover.

18. The rollover meter device of claim 17, wherein one of the control components is a red light that flashes when a lateral rollover is expected rather than possible.

19. A rollover meter device for use with a vehicle, comprising:
a meter housing component comprising:
a first pendulum assembly associated with a first pair of limit switches;
a second pendulum assembly of a different length than the first weighted pendulum assembly and associated with a second pair of limit switches;
a first pair of cams associated with the first pair of limit switches;
a second pair of cams associated with the second pair of limit switches;
wherein the first and second pendulum assemblies drive the first and second pair of cams to actuate the first pair and the second pair of limit switches;
wherein tilting of the vehicle causes a first or second pendulum assembly to contact at least one of the first and second pair of cams which then actuates one of the first or second pairs of limit switches;
a rotation rod for securing the first and second pendulum assemblies;
a pair of outer bushing assemblies that are secured to ends of the rotation rod to allow the rotation rod to rotate; and
a gauge face component that comprises an adjustment knob, a dashboard indicator component, and red and yellow flashing lights to allow a user to monitor a current angle of the vehicle and control corrections required for safe operations; and
wherein the meter housing component is in electrical communication with a vehicle's gas supply, ignition, blade rotation, or Power Take Off (PTO), such that if a critical angle is exceeded and rollover occurs, the rollover meter system automatically shuts off the vehicle's gas supply, ignition, blade rotation, or PTO, and an alarm sounds.

20. The rollover meter device of claim 19, wherein the meter housing component is rigidly attached behind a steering wheel of the vehicle.
